(19) United States
(12) Patent Application Publication
(10) Pub. No.: US 2022/0400613 A1
(43) Pub. Date: Dec. 22, 2022

(54) Cutting device for cutting leaves from plants provided with a cutting cage adjusting device

(71) Applicant: Patrick Michael Antonius van ESCH, Castell-Platja d'Aro Girona (ES)

(72) Inventor: Patrick Michael Antonius van ESCH, Castell-Platja d'Aro Girona (ES)

(21) Appl. No.: 17/660,836

(22) Filed: Apr. 27, 2022

(30) Foreign Application Priority Data
Mar. 19, 2021 (NL) 2027789

(51) Int. Cl. A01D 43/08

(52) U.S. Cl. CPC A01D 43/088

(57) ABSTRACT

An adjusting device 1 of a cutting device has a mounting element 3 which is provided with a first through bore 7 through which a first shaft 9 projects. This first shaft 9 is provided at one end 9a with a rotary adjusting knob 13 and is provided with a second bore 15 which extends over the entire length of the first shaft 9 and is provided with internal screw thread over its entire length. The adjusting device 1 furthermore has an elongate coupling element 19 which can be connected to a device part to be adjusted. This coupling element 19 is provided with a second shaft 21 with an external screw thread, which is turned into the first shaft 9. When the adjusting knob 13 is turned, the second shaft 21 is displaced in the longitudinal direction. The second shaft can be rotated into the second bore 15 at both ends of the first shaft and can protrude from the first shaft at both ends.

### TECHNICAL FIELD OF THE INVENTION

The invention relates to a cutting device for cutting leaves from plants, comprising:
a drum into which the plants to be treated are to be inserted, which drum has a wall provided with openings, during operation the leaves to be cut protrude through the openings,
first rotation means for rotating the drum about a longitudinal axis of the drum,
at least one cutting cage provided with a number of elongate knives, which cutting cage is present next to the drum,
second rotation means for rotating the cutting cage about a longitudinal axis of the cutting cage, wherein in operation the cutting edges of the knives rotate along the outside of the drum, and
an adjusting device capable of adjusting the distance between the longitudinal axis of the cutting cage and the longitudinal axis of the drum.

### Background of the Invention

Such a cutting device is known from US2012/0279193A1. In this known cutting device, the axis of rotation of the cutting cage is eccentric relative to a mounting axis. By turning the axis of rotation about the mounting axis, the distance between the longitudinal axis of the drum and the longitudinal axis of the cutting cage is changed.

### SUMMARY OF THE INVENTION

It is an object of the invention to provide a cutting device of the above-described type in which the means for adjusting the cutting cage restrict the design freedom of the cutting device little. To this end, the cutting device according to the invention is characterized in that the cutting device comprises a device part, as well as a carrier on which the cutting cage is present and which is movably mounted on the device part, wherein the adjusting device can adjust the position of the carrier relative to the device part, said adjusting device comprising:
a mounting element provided with a mounting surface with which the mounting element is mounted on the device part, said mounting element being provided with a first bore extending through the mounting element and being provided with internal screw thread,
a first shaft which is rotatably present in the first bore about the longitudinal axis of the first shaft and which projects with a first end from the first bore and is provided at the first end with an adjusting knob and at a second end with a second bore provided with internal screw thread,
a lock which locks the first shaft against displacement in axial direction, and
an elongate coupling element connected to the carrier in such a way that it is locked against rotation about the longitudinal axis and is provided with a second shaft with external screw thread which is inserted in the first bore, wherein turning the adjusting knob results in displacement of the second shaft in longitudinal direction,
   said second bore extending over the entire length of the first shaft and being provided with internal screw thread along the entire length so that the second shaft at both ends of the first shaft can be inserted into the second bore.

By using such an adjusting device, less space is required for adjustment, so that the cutting device offers more freedom of design.

It is noted that an adjusting device is known from WO2008/136903A1 in which a threaded rod can also be displaced. However, application of this known adjusting device in a cutting device requires high demands on the design of the cutting device in order to make this application possible. In the adjusting device according to the invention, a coupling element provided with a long threaded end can be displaced in axial direction over the entire length of the threaded end, so that a very large adjustment range is possible. In the case of a short threaded end, it can optionally be inserted in both ends of the first shaft, so that the number of situations in which the adjusting device can be used is large.

Preferably the length of the second shaft is such that the second shaft protrudes with both ends from the first shaft.

The adjusting knob is preferably provided with teeth or recesses over the circumference and preferably a spring-loaded pawl mounted on the mounting element (pawl present on a resilient plate that is mounted on the mounting element) is present in the space between adjacent teeth or in one of the recesses and locks the position of the adjusting knob. When the adjusting knob is turned, the pawl comes out of the space between the teeth or the recess and then clicks into an adjacent space or recess.

An embodiment of the cutting device according to the invention is characterized in that the first shaft also projects with the second end from the second bore and the size of the mounting element in a direction parallel to the longitudinal direction of the second bore is a maximum of 2 cm. Because the size of the mounting element in the longitudinal direction of the second bore is smaller than that of the known adjusting device, less mounting space is required on the device part for mounting the adjusting device, so that it can be used in more places.

A further embodiment of the cutting device according to the invention is characterized in that the mounting element is provided with at least one through hole extending in a direction perpendicular to the mounting surface and through which a bolt can be inserted for fixing the mounting element to the device part. In the known adjusting device, the mounting surface of the mounting element being provided with a hole provided with internal screw thread, into which a bolt can be screwed. As a result, this adjusting device can only be fixed to the device part from the side of the mounting surface. With the adjusting device according to the invention, the mounting element can also be fixed to the device part from the opposite side, so that it can be used in more situations.

### BRIEF DESCRIPTION OF THE DRAWINGS

The invention will be further elucidated below on the basis of an exemplary embodiment of the adjusting device according to the invention shown in the drawings, wherein:

FIG. 1 is an embodiment of the cutting device according to the invention provided with a number of adjusting devices,

FIG. 2 is a perspective view of an embodiment of one of the adjusting devices;

FIG. 3 is a top view of the adjusting device shown in FIG. 2; and

FIG. 4 is the adjusting device in cross-section along line in FIG. 3.

### DETAILED DESCRIPTION OF THE DRAWINGS

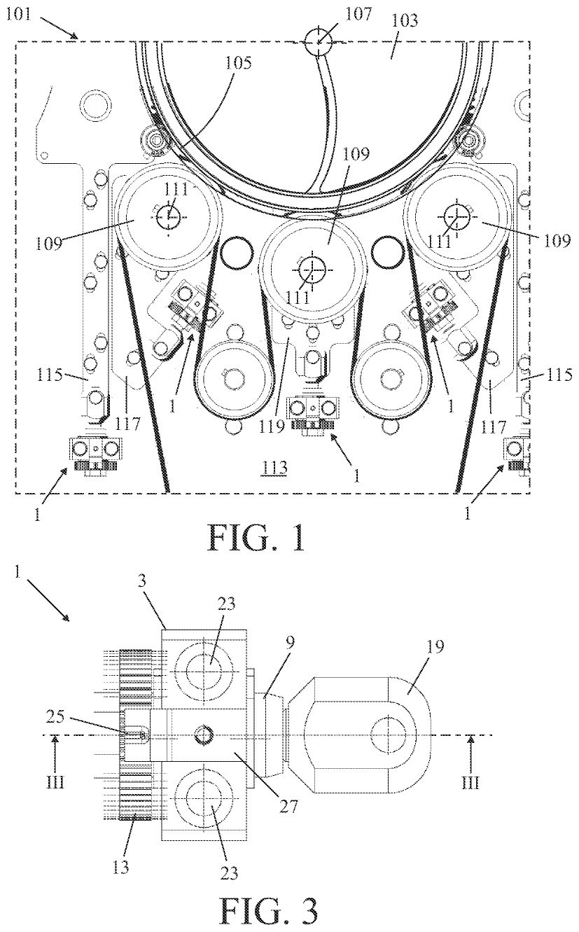

FIG. 1 shows a part of an embodiment of the cutting device according to the invention. The cutting device 101 has a drum 103 into which plants to be treated are to be introduced. This drum 103 has a wall 105 which is provided with openings through which leaves to be cut from the plants protrude during operation. The cutting device 101 further has three cutting cages 109, each provided with a plurality of elongate knives and located adjacent to the drum 103. The drum 103 and the cutting cages 109 are rotated about their longitudinal axes 107 and 111 by first and second rotation means, respectively, with the cutting edges of the knives rotating along the outside of the drum (103).

The cutting cages 109 are present on carriers 115, 117 and 119 which are slidably mounted on a device part 113. A number of adjusting devices 1 are mounted on this device part 113 and are coupled to the carriers 115, 117 and 119. These carriers can be adjusted with respect to the device part 113 and therefore they are able to adjust the longitudinal axes 111 of the cutting cages 109 with respect to the longitudinal axis 107 of the drum 103.

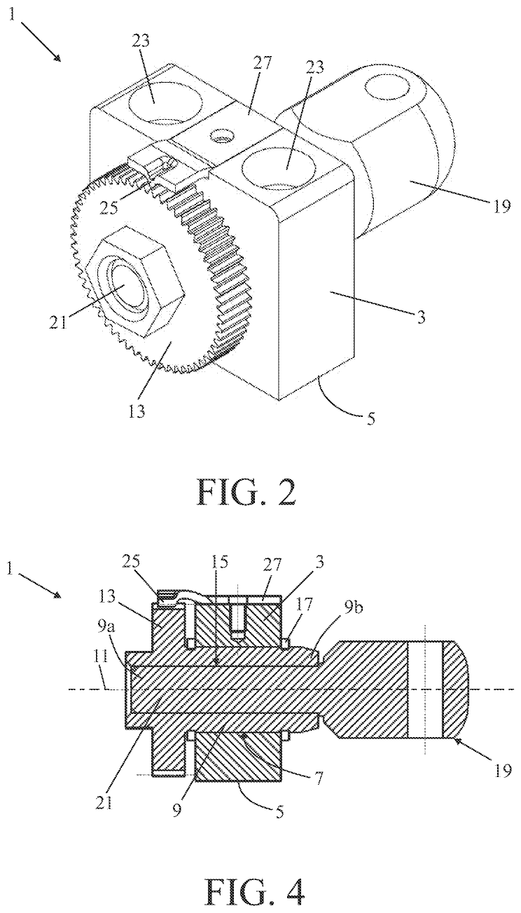

In FIGS. 1, 2 and 3, an embodiment of one of the adjusting devices is shown in perspective, in top view and in section, respectively, along line in FIG. 3. The adjusting device 1 has a mounting element 3 for mounting on the device part 113. This mounting element 3 is provided with a mounting surface 5 with which it can be fixed to the device part 113 (see FIG. 1). The size of the mounting element 3 in a direction parallel to the longitudinal direction of the second bore 15 amounts to a maximum of 2 cm, so that only little space is required to mount the adjusting device 1 on a device part.

The mounting element 3 is provided with a first through bore 7 through which a first shaft 9 projects. This first shaft 9 is rotatable about the longitudinal axis 11 in the bore 7 and projects with both ends 9a and 9b from the first bore 7. At a first end 9a of these ends, the first shaft 9 is provided with a rotary adjusting knob 13 and at the other, second end 9b, the first shaft 9 is provided with a second bore 15 which extends over the entire length of the first shaft 9 and is internally threaded along its entire length. The first shaft 9 is secured against displacement relative to the mounting element 3 in the axial direction by a retaining ring 17.

The adjusting device 1 furthermore has an elongate coupling element 19 which can be connected to the carrier 115, 117, 119 to be adjusted (see FIG. 1) and is thereby secured against rotation about the longitudinal axis. This coupling element 19 is provided with a second shaft 21 with an external screw thread, which is turned into the first shaft 9. When the adjusting knob 13 is turned, the second shaft 21 is displaced in the longitudinal direction. Selectively, at both ends 9a and 9b of the first shaft 9, the second shaft 21 can be rotated in the second bore 15. If the second shaft 21 is sufficiently long, it can extend through the first shaft 9 and project from the first shaft 9 at both ends 9a and 9b.

For the purpose of fastening the mounting element 3 to the device part 113, the mounting element 3 is provided with two through holes 23 extending in a direction perpendicular to the mounting surface 5. Bolts can be inserted through these through holes 23 with which the mounting element 3 can be screwed onto the device part 113.

The rotary adjusting knob 13 is preferably provided with teeth or recesses over the circumference and preferably a spring-loaded pawl 25 on the mounting element 3 (patent on resilient plate 27 which is mounted on mounting element) is present in the space between adjacent teeth or clicks into a recess to lock the position of the adjusting knob 13. When the adjusting knob 13 is turned, the pawl 25 comes out of the space between the teeth or out of the recess and then clicks into an adjacent space or recess.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. A cutting device for cutting leaves from plants, comprising:
a drum into which the plants to be treated are to be inserted, which drum has a wall provided with openings, during operation the leaves to be cut protrude through the openings,
first rotation means for rotating the drum about a longitudinal axis of the drum,
at least one cutting cage provided with a number of elongate knives, which cutting cage is present next to the drum,
second rotation means for rotating the cutting cage about a longitudinal axis of the cutting cage, wherein in operation the cutting edges of the knives rotate along the outside of the drum, and
an adjusting device capable of adjusting the distance between the longitudinal axis of the cutting cage and the longitudinal axis of the drum,
wherein the cutting device comprises a device part, as well as a carrier on which the cutting cage is present and which is movably mounted on the device part, wherein the adjusting device can adjust the position of the carrier relative to the device part, said adjusting device comprising:
a mounting element provided with a mounting surface with which the mounting element is mounted on the device part, said mounting element being provided with a first bore extending through the mounting element and being provided with internal screw thread,
a first shaft which is rotatably present in the first bore about the longitudinal axis of the first shaft and which projects with a first end from the first bore and is provided at the first end with an adjusting knob and at a second end with a second bore provided with internal screw thread,
a lock which locks the first shaft against displacement in axial direction, and
an elongate coupling element connected to the carrier in such a way that it is locked against rotation about the longitudinal axis and is provided with a second shaft with external screw thread which is inserted in the first bore, wherein turning the adjusting knob results in displacement of the second shaft in longitudinal direction,
said second bore extending over the entire length of the first shaft and being provided with internal screw thread along the entire length so that the second shaft at both ends of the first shaft can be inserted into the second bore.

2. Cutting device according to claim 1, wherein the second shaft protrudes with both ends from the first shaft.

3. Cutting device according to claim 1, wherein the first shaft also projects with the second end from the second bore and the size of the mounting element in a direction parallel to the longitudinal direction of the second bore is a maximum of 2 cm.

4. Cutting device according to claim 1, wherein the mounting element is provided with at least one through hole extending in a direction perpendicular to the mounting surface and through which a bolt can be inserted for fixing the mounting element to the device part.
